(19) United States
(12) Patent Application Publication
(10) Pub. No.: US 2006/0044494 A1
(43) Pub. Date: Mar. 2, 2006

(54) Transflective liquid crystal display device and manufacturing method for the same

(76) Inventors: Shie-Chang Jeng, Ping Tung Hsien (TW); Ku-Hsien Chang, Kao Hsiung Hsien (TW); Chi-Chang Liao, Tai Nan City (TW)

Correspondence Address: RABIN & BERDO, P.C.;Suite 500, 1101 14 Street, N.W., Washington, DC, 20005, US

(21) Appl. No.: 11/090,279

(22) Filed: Mar. 28, 2005

(30) Foreign Application Priority Data
Aug. 31, 2004 (TW) 93126249

(51) Int. Cl. G02F 1/1335

(52) U.S. Cl. 349/114

(57) ABSTRACT

A transflective liquid crystal display device and, manufacturing method for the same are described. Two kinds of liquid crystals with different Δn values are injected into a reflective region and a transmissive region in a transflective liquid crystal display respectively. If the value Δn of the transflective region is double that of the reflective region, the present, invention provides its optimal optical design in a signal cell gap of the transflective liquid crystal display.

### BACKGROUND OF THE INVENTION

1. Field of the Invention

The present invention relates to a transflective liquid crystal display device and manufacturing method for the same, and more particularly to a single cell gap of the transflective liquid crystal display produced by injecting two kinds of liquid crystals with different Δn values into a reflective region and a transmissive region respectively.

2. Description of Related Art

A transmissive liquid crystal display maintains a good display quality in a dark environment, but has a bad display quality under the sun or in a very bright environment. The image is faded and the contrast is dropped in a bright environment. Unlike the transmissive liquid crystal display, a reflective liquid crystal display is dependent on external light sources for the display effect. Therefore, reflective liquid crystal displays have better performance and contrast outdoors or in a bright situation, and can greatly reduce the power consumption of the backlight. Reflective liquid crystal displays are thus suitable for portable display products, but they cannot be used in dark environments. Even though this problem can be solved by adding a light source at the front, such arrangement will cause a deterioration of image quality. A transflective liquid crystal display becomes a design of combining the advantages of both transmissive and reflective liquid crystal displays and uses a backlight and an ambient light source at the same time.

Since the total length of the light path is different for the transmissive region and the reflective region, the early design of single cell gap transflective liquid crystal display cannot achieve the optimal optical performance. For example, a normally white transflective liquid crystal display is in the bright state for both of the transmissive region and reflective region when no voltage is applied. In such condition, a phase retardation Δn×d should be λ/2 in the transmissive region and the phase retardation Δn×d should be λ/4 in the reflective region for the light path in order to reach the optimal optical performance. However, the transmissive region and the reflective region cannot concurrently satisfy the above requirements in a single cell gap design. To improve the optical performance of the transflective liquid crystal display, a multi-cell gap design is developed to overcome the phase retardation problem of the light path of the transmissive region having a phase retardation double that of the reflective region.

In the prior art design of dual cell gaps, the Sharp Corporation suggested a transflective liquid crystal display structure as shown in FIG. 1. The cell gap in the reflective region is half of the transmissive region. This design provides a phase retardation, of the light path of λ/2 in the transmissive, region, and a phase retardation of the light path of λ/4 in the reflective region. The multi-cell gap design provides an optimal optical performance, but it is necessary to precisely control the dual cell gap in the manufacturing process. Thus, the yield rate is lowered and the manufacturing cost is increased.

To simplify the complexity, of a dual cell gap design, the Electronics Research & Service Organization of Industrial Technology Research Institute suggests a single cell gap design with two thin film transistors (TFT) as shown in FIG. 2. The two TFTs control the driving voltages of the reflective region and the transmissive region separately. This design satisfies the phase retardation requirements of the light in the transmissive region and the reflective region and achieves an optimal image quality. The design, however, has the shortcomings of a complex driving circuit and an increase of power consumption.

The Electronics Research & Service Organization of Industrial Technology Research Institute also suggests another single cell gap design for, the transflective liquid crystal display as shown in FIG. 3. A photo-alignment technology is used to form two pretilt angles on the transmissive region and the reflective region. The dual pretilt angles method satisfies the phase retardation requirements of the light in the transmissive region and the reflective region individually. However, the photo-alignment technology is immature and the performance is unstable.

### SUMMARY OF THE INVENTION

The primary object of the present invention is to provide a single cell gap transflective liquid crystal display device and manufacturing method for the same. Two kinds of liquid crystals with different Δn values are injected into a reflective region and a transmissive region separately. The Δn of the transflective region is approximately double that of the reflective region. This design satifies phase retardation requirements of being λ/2 for the light design satisfies the phase retardation requirements of being λ/2 for the light passing through the transmissive region, and λ/4 for the light passing the reflective region in a single cell gap, and thus could reach an optimal optical performance.

To achieve the above object, the present invention provides a single cell gap transflective liquid crystal display device, including an upper substrate and a lower substrate. A liquid crystal layer with two different Δn is formed in a gap between the upper substrate and the lower substrate, and the gap is a signal cell gap. An alignment layer is located between the liquid crystal layer and the upper substrate and the lower substrate. A reflector is formed on the lower substrate and served as a reflective region. A transparent electrode is formed on the upper and lower substrates, in which a transmissive region is a region not covered by the reflector. A plurality of isolating walls is provided for separating the reflective region and the transmissive region, in which the reflective region and the transmissive region have liquid crystals with different Δn values. Those isolated walls also serve as the spacers of the transflective LCD to maintain a constant cell gap. A first polarizer is located on an external side of the upper substrate. A second polarizer is located on an external side of the lower substrate. A first optical retardation film is located between the first polarizer and the upper substrate. A second optical retardation film is located between the second polarizer and, the lower substrate. A backlight is located below the external surface of the lower substrate.

The present invention also provides a manufacturing method for a transflective liquid crystal display device, comprising the steps of carrying out a pair of substrates with retardation films and polarizers on the outer surfaces; forming a reflector on a reflective region of the lower substrate and a transparent electrode on the upper and lower substrate, such that the transmissive region is not covered by the reflector; forming alignment layers between the liquid crystal layer and the upper substrate and the lower substrate; forming a plurality of isolating walls on the internal sides of the upper substrate or the lower substrate, such that the isolating walls are located between the upper substrate and the lower substrate to define the separate reflective and transmissive regions; forming a liquid crystal layer by injecting a plurality of liquid crystals with different Δn values into the reflective region and the transmissive region respectively, where the liquid crystal layer is a single cell gap; finally assembling the first and the second substrates and placing a backlight module outside the lower substrate.

### BRIEF DESCRIPTION OF THE DRAWINGS

The various objects and advantages of the present invention will be more readily understood from the following detailed description when read in conjunction with the appended drawings, in which:

FIG. 1 is a schematic view of the structure of a dual cell gap liquid crystal display of a prior art;

FIG. 2 is a schematic view of the structure of a single cell gap of the two thin film transistors of a prior art;

FIG. 3 is a schematic view of the structure of the transflective liquid crystal display with two pretilt angles according to a prior art;

FIGS. 4A to 4H are schematic views of the process method of the transflective liquid crystal display device of the present invention; and

FIG. 4H is a schematic view of the transflective liquid crystal display device of the present invention.

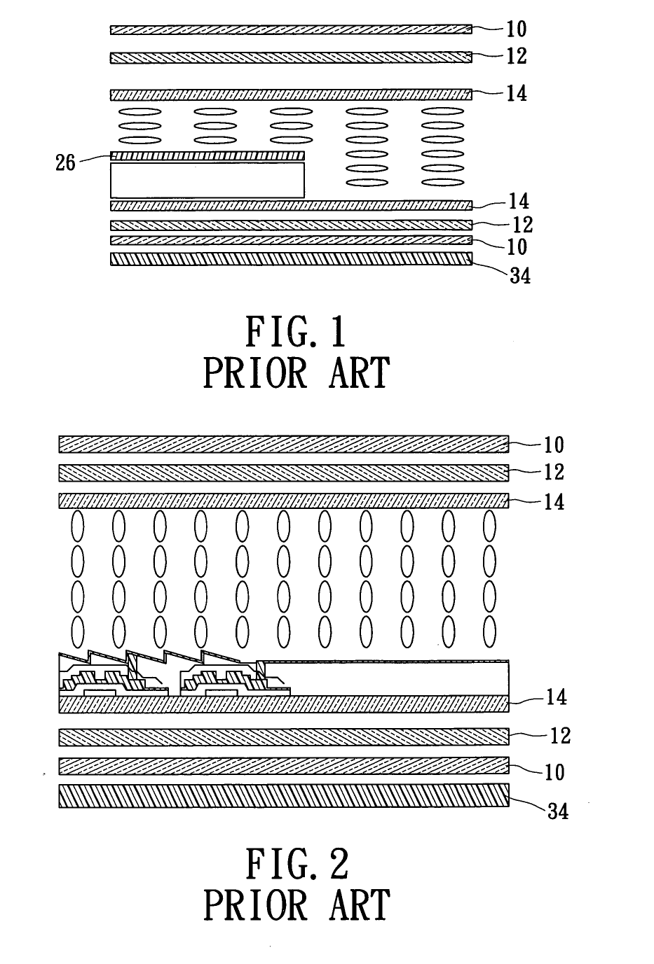

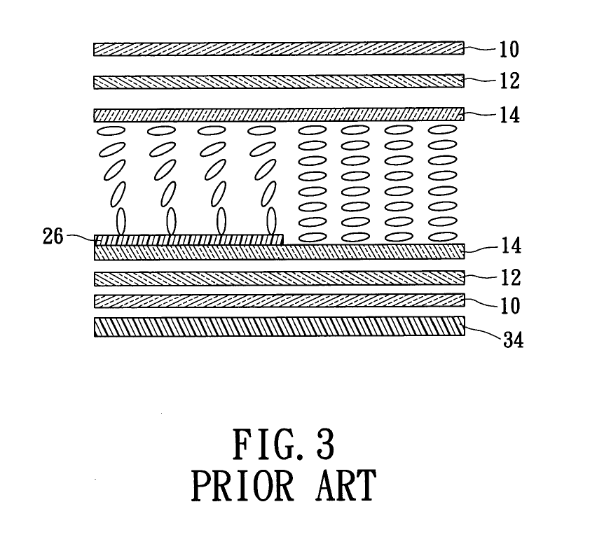

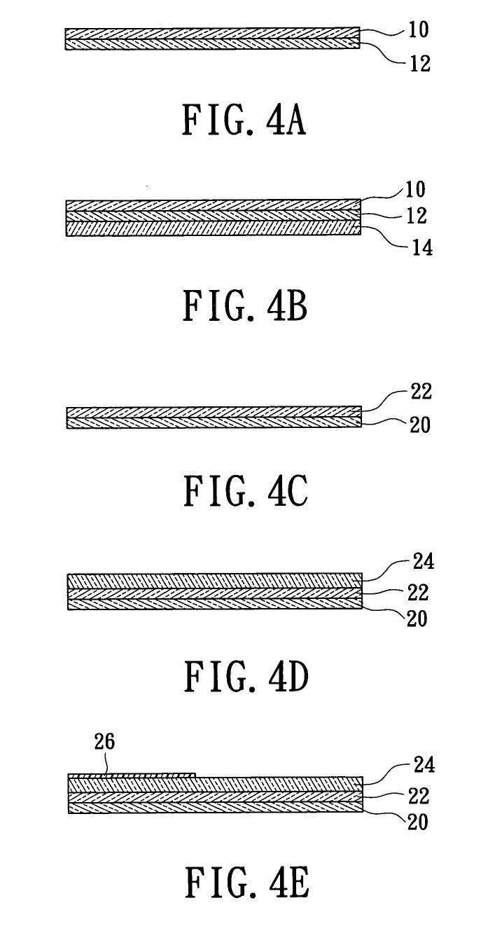

### DETAILED DESCRIPTION OF PREFERRED EMBODIMENTS

The present invention relates to a single cell gap transflective liquid crystal display by injecting two kinds of liquid crystals with different Δn values into a reflective region and a transmissive region, respectively.

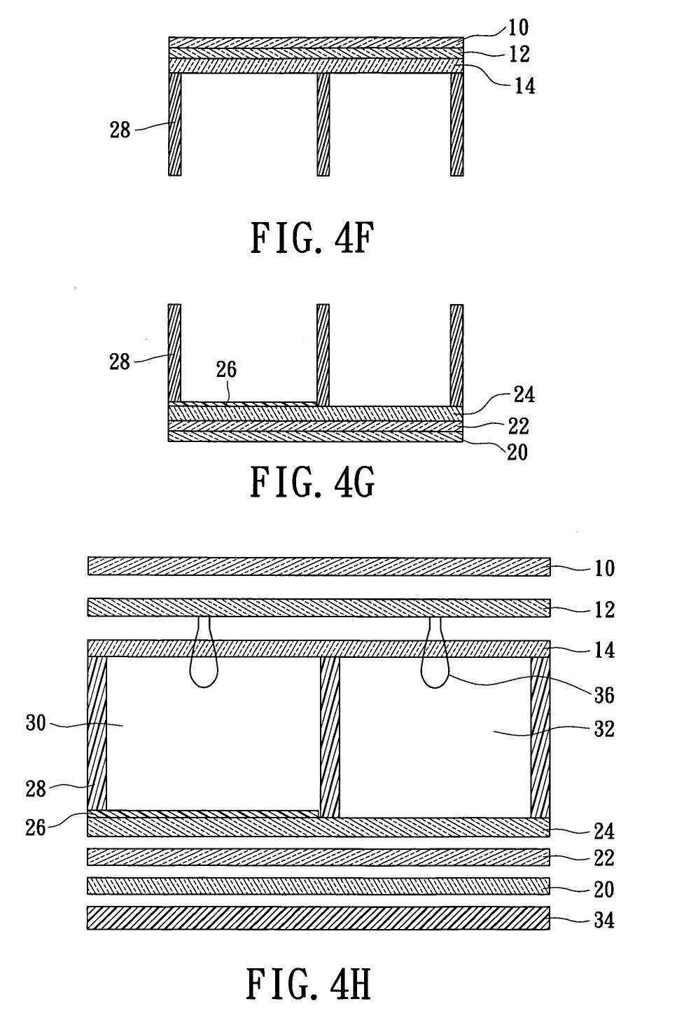

FIGS. 4A to 4G are schematic views of the process method of the transflective liquid crystal display device of the present invention. FIGS. 4A and 4B are schematic views of a first substrate of the transflective liquid crystal display. A first polarization layer 10 is located on an external side of a first optical retardation film 12 as shown in FIG. 4A and an upper substrate 14 is provided on the first optical retardation film 12 as shown in FIG. 4B, in which the upper substrate could be a glass substrate or a plastic substrate. The plastic substrate could be any transparent material, such as a Polyesterurethane (PET), a Polyethersulfone (PES) and a MetallocenebasedCyclicblefinCopolymer (MCOC). The optical retardation film 12 here could be a λ/4 film.

FIGS. 4C to 4E are schematic views of a second substrate of the transflective liquid crystal display. A second polarization layer 20 is located on an external side of a second optical retardation film 22 as shown in FIG. 4C and a lower substrate 24 is provided on the second optical retardation film 22 as shown in FIG. 4D, in which the lower substrate could be a glass substrate or a plastic substrate. The plastic substrate could be any transparent material, such as a Polyesterurethane (PET), a Polyethersulfone (PES) and a MetallocenebasedCyclicOlefinCopolymer (MCOC). The optical retardation film 12 here could be a λ/4 film.

A reflector 26 is formed on the lower substrate 24, which defines a reflective region (not shown in the figure) as shown in FIG. 4E, in which the method of forming the reflector 26 could be sputtering deposition, casting, coating and molding. The reflector could be made of a material, such as aluminum, barium sulfate and titanium dioxide. A transparent electrode (not shown in the figure) is formed on the internal side of the upper substrate 14 and the lower substrate 24, in which the transmissive region is the region not covered by the reflector. A plurality of isolating walls is formed on the internal side of the upper or lower substrate and located between the upper substrate and the lower substrate to define a reflective region and a transmissive region as illustrated in FIGS. 4F and 4G. Those isolating walls could be manufactured by a method, such as photolithography, molding, printing and a photopolymerization. Next, a liquid crystal layer is formed by injecting a plurality of liquid crystals 36 with different Δn values into the reflective region 30 and the transmissive region 32, and the liquid crystal layer is a single cell gap. The step of injecting a plurality of liquid crystals with different Δn values could be accomplished by a method, such as inkjet printing or one-drop-fill (ODF). The value Δn of the transflective region is double that of the reflective region in order to satisfy the optimal optical performance, which a phase retardation is λ/2 for the light passing through the transmissive region and λ/4 for the light passing the reflective region in the single cell gap transflective LCD.

FIG. 4H is a schematic view of the transflective liquid crystal display device of the present invention, comprising an upper substrate 14 and a lower substrate 24. The upper substrate 14 and the lower substrate 24 could be either glass or plastic substrates. A liquid crystal layer is formed in a gap between the upper substrate and the lower substrate, and the gap is a signal cell gap. An alignment layer (not shown in the figure) is located between the liquid crystal layer and the upper substrate, and another alignment layer (not shown in the figure) is located between the liquid crystal layer and the lower substrate. A reflector 26 is formed on the internal side of the lower substrate to serve as a reflective region 30. The reflector 26 could be formed by a method, such as sputtering deposition, casting, molding and coating. The driving method could be either an active driving mode or a passive driving mode, wherein the active matrix component or the passive electrode layer (not shown in the figure) is located on the lower substrate. When the device is operated in the active driving mode, a thin film transistor could be located beneath the reflector 26 in order to increase the aperture ratio. A transparent electrode (not shown in the figure) is formed on the internal side of the lower and upper substrates, in which a transmissive region 32 is a region not covered by the reflector 26. A plurality of isolating walls 28 separates the reflective region 30 and the transmissive region 32, in which the reflective region and the transmissive region have liquid crystals with different Δn values. These walls could be manufactured by a method, such as photolithography, molding, printing or a photopolymerization. A first polarizer 10 is located on an external side of the upper substrate 14. A second polarizer 20 is located on an external side of the lower substrate 24. A first optical retardation film 12 is located between the first polarizer 10 and the upper substrate 14. A second optical retardation film 22 is located between the second polarizer 20 and the lower substrate 24.

The first optical retardation film and the second optical retardation film are λ/4 wave plates. A backlight module 34 is located below the external surface of the lower substrate. The backlight module 34 could be a side-edged type backlight module or a direct type backlight module. A flexible direct type backlight module or a side-edged type backlight with a flexible light guide should be used and located on the external side of the lower substrate in order to form a flexible transflective liquid crystal display. The flexible direct type backlight could be a light source, such as organic light emitting diodes (OLED), polymer light emitting diodes (PLED), an electroluminescent source and a microdischarge source, fabricated on a flexible substrate.

Two kinds of liquid crystals with different Δn values are individually injected into the reflective region 30 and the transmissive region 32, where the value Δn of the transflective region is double that of the reflective region in order to satisfy the optimal optical performance. The phase retardation is thus λ/2 for the light passing through the transmissive region, and the phase retardation is λ/4 for the light passing through the reflective region. The liquid crystal layer is a single cell gap.

The present invention also serves as a flexible transflective liquid crystal display, due to a flexible upper substrate, a flexible lower substrate, a plurality of isolating walls and, flexible backlight module. The isolating walls of present invention could maintain a constant cell gap of the flexible transflective liquid crystal display under a bending condition.

The present invention could also serve as a color transflective LCD. For example, if a color filter is installed at a corresponding region on the substrate, the device becomes a color transflective liquid crystal display.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. A transflective liquid crystal display device, comprising:
an upper substrate and a lower substrate;
a liquid crystal layer, formed in a gap between the upper substrate and the lower substrate, wherein the gap is a signal cell gap;
a reflector, formed on an internal side of the lower substrate and served as a reflective region;
a transparent electrode, formed on the upper and lower substrates, and having a transmissive region which is a region not covered by the reflector;
alignment layers located between the liquid crystal layer and the upper substrate and the lower substrate;
a plurality of isolating walls, for separating the reflective region and the transmissive region, and the reflective region and the transmissive region have liquid crystals with different Δn values;
a first polarizer, disposed on an external side of the upper substrate;
a second polarizer, disposed on an external side of the lower substrate; and
a backlight module located under an external surface of the lower substrate.

2. The transflective liquid crystal display device as claimed in claim 1, further comprising a first optical retardation film located between the first polarization layer and the upper substrate.

3. The transflective liquid crystal display device as claimed in claim 2, wherein the first optical retardation film is a λ/4 wave plate.

4. The transflective liquid crystal display device as claimed in claim 1, further comprising a second optical retardation film located between the second polarization layer and the lower substrate.

5. The transflective liquid crystal display device as claimed in claim 4, wherein the first optical retardation film is a λ/4 wave plate.

6. The transflective liquid crystal display device as claimed in claim 1, wherein the value of Δn of the transmissive region is approximately double that of the reflective region.

7. The transflective liquid crystal display device as claimed in claim 1, wherein the backlight module is a side-edged type backlight module or a direct type backlight module.

8. The transflective liquid crystal display device as claimed in claim 1, wherein the transflective liquid crystal display device serves as a flexible transflective liquid crystal display when a flexible direct type backlight module or a side-edged type light source with a flexible light guide are located on the external side of the lower substrate.

9. The transflective liquid crystal display device as claimed in claim 8, wherein the flexible direct type backlight module is a light source like an Organic Light-Emitting Diode, a Polymer Light Emitting Diode, an Electroluminescent or a microdischarge.

10. The transflective liquid crystal display device as claimed in claim 1, further comprising a layer of color filter located on the inner surface of the substrate to form a color transflective liquid crystal display.

11. The transflective liquid crystal display device as claimed in claim 1, wherein the upper substrate and the lower substrate are glass or plastic substrates.

12. The transflective liquid crystal display device as claimed in claim 11, wherein the plastic substrate is made from the material, such as a Polyesterurethane (PET), a Polyethersulfone (PES) or a MetallocenebasedCyclicOlefinCopolymer (MCOC) substrate.

13. The transflective liquid crystal display device as claimed in claim 1, wherein the device is driven either in an active mode or a passive mode.

14. The transflective liquid crystal display device as claimed in claim 1, further comprising an active matrix component or a passive electrode layer, wherein the active matrix component or the passive electrode layer is located on the lower substrate.

15. A manufacturing method of the transflective liquid crystal display device, comprising:
providing a first substrate and a second substrate;
forming a reflector on a reflective region of the lower substrate, and forming a transparent electrode on a transmissive region of the lower substrate, wherein the transmissive region is the region not covered by the reflector;
forming an electric conductor layer and an alignment layer on the inside of the first substrate and second substrate;
forming a plurality of isolating walls either on an internal side of the upper substrate or an internal side of the lower substrate, wherein the plurality of isolating walls is located between the upper substrate and the lower substrate to define a reflective region and a transmissive region;
forming a liquid crystal layer by injecting a plurality of liquid crystals with different Δn values into the reflective region and the transmissive region respectively, wherein the liquid crystal layer is a single cell gap;
assembling the first substrate and the second substrate, wherein a first optical film module is located on an external side of the first substrate, and a second optical film module is located on an external side of the second substrate; and
placing a backlight module under an external surface of the lower substrate.

16. The manufacturing method of the transflective liquid crystal display device as claimed in claim 15, wherein the transflective liquid crystal display device becomes a part of a flexible transflective liquid crystal display when a flexible direct type backlight module or a side-edged type light source with a flexible light guide are located on the external side of the lower substrate.

17. The manufacturing method of the transflective liquid crystal display device as claimed in claim 15, wherein the methods of forming the reflector include sputtering deposition, casting, molding and coating.

18. The manufacturing method of the transflective liquid crystal display device as claimed in claim 17, wherein the material of the reflector includes metal, such as aluminum, and barium sulfate and titanium dioxide.

19. The manufacturing method of the transflective liquid, crystal display device as claimed in claim 15, a layer of color filter could be fabricated by either the photolithography or injecting color ink to the isolating walls served as the bank structure for producing the color transflective liquid crystal display.

20. The manufacturing method of the transflective liquid crystal display device as claimed in claim 15, wherein the method of making the isolating walls includes photolithography, molding, printing and photopolymerization.

21. The manufacturing method of the transflective liquid crystal display device as claimed in claim 15, wherein the step of injecting a plurality of liquid crystals with different Δn values in the reflective and transmissive regions is accomplished by a method such as an inkjet printing and one-drop-fill (ODF).

22. The manufacturing method of the transflective liquid crystal display component as claimed in claim 15, wherein the first optical film module includes a polarizer and an optical retardation film.

23. The manufacturing method of the transflective liquid crystal display component as claimed in claim 15, wherein the second optical film module includes a polarizer and an optical retardation film.
